(19) United States
(12) Patent Application Publication
(10) Pub. No.: US 2017/0013037 A1
(43) Pub. Date: Jan. 12, 2017

(54) MEDIA FRAGMENT ROTATION METHOD, CLIENT AND SYSTEM

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventors: Peng CANG, Beijing (CN); Qiang LI, Beijing (CN); Hailin REN, Beijing (CN)

(73) Assignees: LE HOLDINGS (BEIJING) CO., LTD., Beijing (CN); LE SHI ZHI XIN ELECTRONIC TECHNOLOGY (TIANJIN) LIMITED, Beijing (CN)

(21) Appl. No.: 15/102,268

(22) PCT Filed: Dec. 5, 2014
(86) PCT No.: PCT/CN2014/093188

§ 371 Date: Jun. 6, 2016

(30) Foreign Application Priority Data
Dec. 6, 2013 (CN) 201310664166.9
Dec. 9, 2013 (CN) 201310665514.4

(51) Int. Cl. H04L 29/06; H04L 29/08

(52) U.S. Cl. CPC H04L 65/60; H04L 67/06; H04L 67/42; H04L 67/02; H04L 65/4076

(57) ABSTRACT

A method, client and system are provided for a carousel media fragment. The method includes acquiring an index list continuously updated by a server. An updated index list is acquired and the old list is discarded. The sequence of a media fragment currently to be downloaded is recorded when discarding the old index list. The sequence of the media fragment ranking is identified in first broadcast place on the updated index list. When determining that the two sequences are different and discontinuous, an absent sequence is added therebetween. A supplemental broadcast address of a corresponding media fragment is generated according to the added sequence and the recorded sequence. According to the corresponding sequence, the supplemental broadcast address and the broadcast address on the updated index list are sequentially combined to obtain a current index list. The corresponding media fragment is downloaded for broadcasting according to the broadcast address.

### CROSS-REFERENCE

This application is based upon Chinese Patent Application 201310664166.9, titled “Method, Client and System of Carousel Media Fragment”, filed on Dec. 6, 2013, and Chinese Patent Application 201310665514.4, titled “Method for Downloading Video Based On HLS Protocol and Device Thereof”, filed on Dec. 9, 2013, the entire contents of which are incorporated herein by reference.

### TECHNICAL FIELD

The present application relates to the field of streaming media broadcast, and more particularly, to a method, a client and a system of a carousel media fragment.

### BACKGROUND

A HLS (Http live streaming) protocol is a streaming media network transmission protocol based on a HTTP protocol proposed by Apple Inc., which can achieve the live broadcast and on-demand of media. Different from common streaming media live broadcast protocol, the data stream acquired by the client performing the HLS live broadcast is not complete, and a latest live data stream is stored as a continuous, short-duration media fragment (MPEG-TS, Moving Pictures Experts Group-Transport Stream) in the server-side. Therefore, the client needs to continuously download and broadcast these media fragments in order to achieve the HLS live broadcast.

At present, the HLS protocol does not support the carousel mode. However, the form of the carousel mode is similar to the live broadcast. The data stream broadcasted by the server-side is not the live data stream, rather than pre-manufactured data, such as movies, TV plays, variety shows, videos and so on. Therefore, the HLS live broadcast mode may be considered to be a basis to achieve the carousel mode.

However, the broadcast requirement for the live broadcast mode is greatly different from that for the carousel mode, so that there are still some problems required to be solved to achieve the carousel mode by means of the HLS live broadcast. For instance, when the network generates the jitters during the HLS live broadcast, the media fragments broadcasted by the client often fall behind the media fragments latest issued by the server-side, which fails to maintain the synchronization with the server-side. At this point, the HLS protocol specifies that the client needs to automatically discard the media fragments that fall behind and have not been broadcasted yet and directly broadcast the latest media fragments updated by the server to rapidly catch up with the media fragment latest issued by the server to ensure the real-time of the live broadcast. During the course of broadcasting the video, a hop occurs from one time period to another time period rapidly.

Moreover, for the carousel mode, the broadcast requirement is to ensure the integrity of the broadcast as far as possible, while the above HLS live broadcast technology is apparently not suitable for achieving the broadcast requirement of the carousel mode. However, the current HLS protocol does not support the carousel technology. In this way, how to deal with the feature of automatically discarding the media fragments in live broadcast specified in the HLS protocol to achieve the carousel mode by effectively using the HLS live broadcast technology becomes a technical problem to be urgently solved.

### SUMMARY

The technical problem to be solved in the present application is to provide a method, a client and a system of a carousel media fragment to deal with features of automatically discarding the media fragments in live broadcast specified in a HLS protocol, thereby effectively utilizing a HLS live broadcast technology to achieve a carousel mode.

To achieve the foregoing object, the embodiments of the present application adopt the following technical solutions.

According to a first aspect, a method of a carousel media fragment is provided. The method includes:

acquiring an index list continuously updated by a server, wherein the index list updated every time is provided with broadcast addresses of multiple latest media fragments to be broadcasted in order and a corresponding unique sequence;

acquiring the updated index list and discarding an old index list, recording a sequence of a media fragment currently to be downloaded when discarding the old index list, and identifying a sequence of a media fragment ranking in a first broadcast place in the updated index list; and

when determining that the two sequences are different and not continuous, adding an absent sequence between the two sequences, generating a supplemental broadcast address of a corresponding media fragment according to the added sequence and the recorded sequence, sequentially combining the supplemental broadcast address and the broadcast addresses in the updated index list according to a corresponding sequence to obtain a current index list, and downloading the corresponding media fragment from a server for broadcasting according to the broadcast addresses in the current index list in order.

According to a second aspect, a computer-readable storage medium recording a program configured to execute the above method is provided.

According to a third aspect, a method a carousel media fragment. The method includes:

acquiring an index list continuously updated by a server, wherein the index list updated every time is provided with broadcast addresses of multiple latest media fragments to be broadcasted in order and a corresponding unique sequence;

acquiring the updated index list and discarding an old index list, recording a sequence of a media fragment currently to be downloaded when discarding the old index list, and identifying a sequence of a media fragment ranking in a first broadcast place in the updated index list; and

when determining that the two sequences are different and continuous, generating the supplemental broadcast address of the corresponding media fragment according to the recorded sequences, sequentially combining the supplemental broadcast address and the broadcast addresses in the updated index list according to the corresponding sequence to obtain the current index list, and downloading the corresponding media fragment from the server for broadcasting according to the broadcast addresses in the current index list in order.

According to a fourth aspect, a computer-readable storage medium recording a program configured to execute the above method is provided.

According to a fifth aspect, a client of a carousel media fragment is provided, wherein the client includes a request module, an analysis module, a recording module, an arranging module, an acquisition and broadcast module, a determining module and a downloading module.

The request module is configured to send a request to a server to acquire an index list continuously updated by the server, wherein the index list updated every time is provided with broadcast addresses of multiple latest media fragments to be broadcasted in order and a corresponding unique sequence.

The analysis module is configured to acquire the updated index list and discard an old index list, and identity a sequence of a media fragment ranking in a first broadcast place in the updated index list.

The recording module is configured to record a sequence of a media fragment currently to be downloaded when discarding the old index list, and identifying the sequence of the media fragment ranking in a first broadcast place in the updated index list.

The arranging module is configured to, when comparing and then determining that the two sequences are different and not continuous, add an absent sequence between the two sequences, generate a supplemental broadcast address of a corresponding media fragment according to the added sequence and the recorded sequences, and sequentially combine the supplemental broadcast address and the broadcast addresses in the updated index list according to a corresponding sequence to obtain a current index list.

The acquisition and broadcast module is configured to download the corresponding media fragment from a server for broadcast according to broadcast addresses in the current index list in order.

According to a sixth aspect, a client of a carousel media fragment is provided, wherein the client includes a request module, an analysis module, a recording module, a arranging module, an acquisition and broadcast module, a determining module and a downloading module.

The request module is configured to send a request to a server to acquire an index list continuously updated by the server, wherein the index list updated every time is provided with broadcast addresses of multiple latest media fragments to be broadcasted in order and a correspondingly unique sequence.

The analysis module is configured to acquire the updated index list and discard an old index list, and identity a sequence of a media fragment ranking in a first broadcast place in the updated index list;

the recording module is configured to record a sequence of a media fragment currently to be downloaded when discarding the old index list, and identifying the sequence of the media fragment ranking in a first broadcast place in the updated index list;

the arranging module is configure to, when comparing and then determining that the two sequences are different and continuous, generate a supplemental broadcast address of a corresponding media fragment according to the recorded sequences, sequentially combine the supplemental broadcast address and the broadcast addresses in the updated index list according to the corresponding sequence to obtain the current index list;

the acquisition and broadcast module is configured to download the corresponding media fragment from the server for broadcasting according to the broadcast addresses in the current index list in order.

According to a seventh aspect, a system of a carousel media fragment is provided, and the system includes one or more clients or servers, wherein the client, including the above client of the carousel media fragment; and the server is configured to continuously update an index list, wherein the index list updated every time is provided with broadcast addresses of multiple latest media fragments to be broadcasted in order and a corresponding unique sequence.

### BRIEF DESCRIPTION OF THE DRAWINGS

FIG. 1 is a flowchart of a method according to a first embodiment of the present application.

FIG. 2 is a flowchart of a method according to a second embodiment of the present application.

FIG. 3 is a flowchart of a method according to a third embodiment of the present application.

FIG. 4 is a flowchart of a method according to a fourth embodiment of the present application.

FIG. 5 is a schematic diagram of an m3u8 file according to the fourth embodiment of the present application.

FIG. 6 is a schematic diagram of a local m3u8 file according to the fourth embodiment of the present application.

FIG. 7 is a structural drawing of a client according to a fifth embodiment of the present application.

FIG. 8 is a structural drawing of a client according to a sixth embodiment of the present application.

FIG. 9 is a structural drawing of a client according to a seventh embodiment of the present application.

FIG. 10 is a structural drawing of a client according to an eighth embodiment of the present application.

FIG. 11 is a frame chart of a system according to a ninth embodiment of the present application.

### PREFERRED EMBODIMENTS OF THE APPLICATION

The embodiments of the present application will be explained in details with reference to the drawings and embodiments hereinafter, so that the realization process of how to solve the technical problems using a technical means and achieve the technical effect can be fully understood and implemented accordingly.

The media fragments hereinafter may be moving pictures experts group-transport stream (MPEG-TS) and other streaming media fragment format file, and the present application is certainly not limited herein.

The index list hereinafter may be m3u8 file and other index directory file, and the present application is certainly not limited herein.

The broadcast address hereinafter may be uniform resource locator (URL) and other network access address, and the present application is certainly not limited herein.

### First Embodiment

When the network generates the jitters during the HLS live broadcast, the media fragments broadcasted by the client often fall behind the media fragment latest issued by the server-side, which fails to maintain the synchronization with the server-side. At this point, the HLS protocol specifies that the client needs to automatically discard the media fragments that fall behind and have not been broadcasted yet and directly broadcast the latest media fragments updated by the server to rapidly catch up with the media fragment latest issued by the server to ensure the real-time of the live broadcast. A hop occurs during the course of broadcasting the video.

Apparently, the media fragment currently broadcasted by the client and the latest media fragment, updated by server, directly broadcasted by the client are not continuous during the broadcast. The absent media fragment leading to discontinuity is supplemented by the client itself, which is considered in the solution of the present application. After the media fragment currently broadcasted is performed completely, the self-supplemented media fragment is broadcasted, and then the latest media fragment updated by the server is broadcasted. In this way, the complete broadcast in the carousel mode may be ensured.

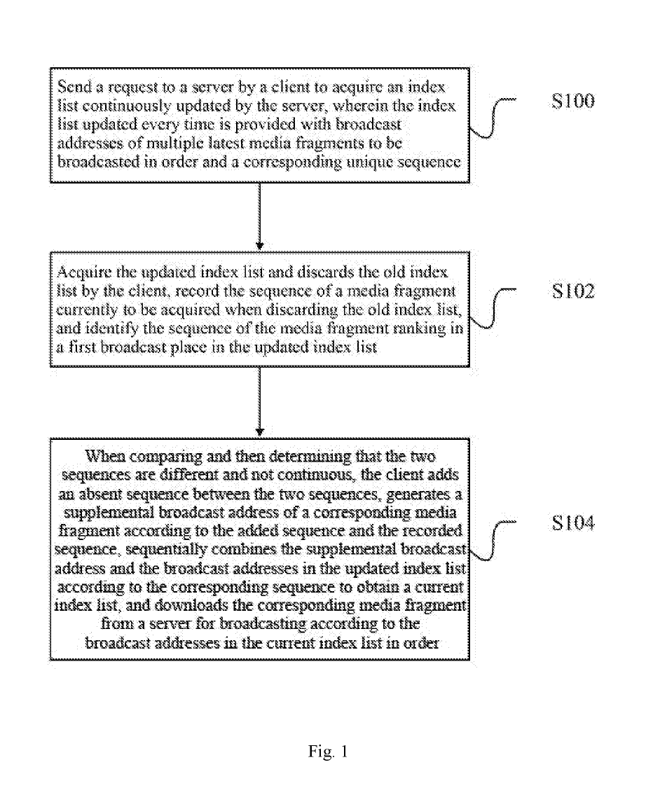

FIG. 1 shows a flowchart of a method according to a first embodiment of the present application. The method includes the following steps.

In step S100, a client sends a request to a server to acquire an index list continuously updated by the server, wherein the index list updated every time is provided with broadcast addresses of multiple latest media fragments to be broadcasted in order and a corresponding unique sequence.

The arrangement sequence between the media fragment and other media fragment is identified by the sequence. Therefore, the sequence itself and the broadcast address of the media fragment have a corresponding relation.

In step S102, the client acquires the updated index list and discards the old index list, records the sequence of a media fragment currently to be downloaded when discarding the old index list, and identifies the sequence of the media fragment ranking in a first broadcast place in the updated index list.

It should be noted that the sequence of the media fragment currently to be downloaded when discarding the old index list is also a media fragment that is not downloaded successfully.

In step S104, when comparing and then determining that the two sequences are different and not continuous, the client adds an absent sequence between the two sequences, generates a supplemental broadcast address of a corresponding media fragment according to the added sequence and the recorded sequence, sequentially combines the supplemental broadcast address and the broadcast addresses in the updated index list according to the corresponding sequence to obtain a current index list, and downloads the corresponding media fragment from a server for broadcasting according to the broadcast addresses in the current index list in order.

When adding the absent sequence between the two sequences, the absent sequence between two discontinuous sequences may be obtained according to the arrangement relation prior to the sequence specifically, because the sequence is a digit in general. In the meantime, the sequence recorded in the step S102 is also a media fragment that is not downloaded successfully.

The corresponding supplemental broadcast address may be generated according to the media fragment of the added sequence and the media fragment with the recorded sequence by means of the corresponding relation between the sequence and the broadcast address of the media fragment. According to the arrangement sequence of the sequence s, the supplemental broadcast address is arranged between the media fragment currently broadcasted and the latest broadcast address updated by the server. It should be noted that multiple supplemental broadcast addresses are also arranged according to the arrangement sequence of the sequences as there is not only one added sequence.

After broadcasting the current media fragments, the media fragments are firstly downloaded in the supplemental broadcast address for broadcasting, and then the media fragments are downloaded in the latest broadcast address updated by the server for broadcasting. In this way, the broadcast integrity is implemented.

### Second Embodiment

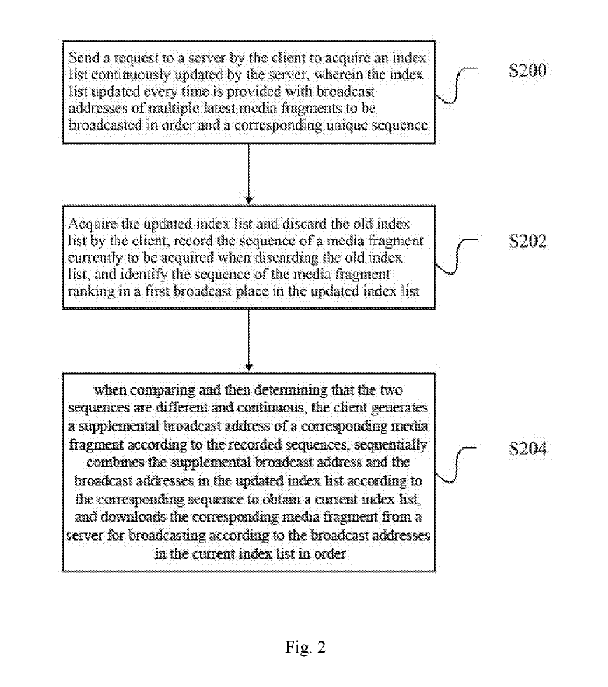

FIG. 2 shows a flowchart of a method according to a second embodiment of the present application. The method includes the following steps.

When the network generates the jitters during the HLS live broadcast, the media fragments broadcasted by the client often fall behind the latest media fragment issued by the server-side, which fails to maintain the synchronization with the server-side. At this point, the HLS protocol specifies that the client needs to automatically discard the media fragments that fall behind and have not been broadcasted yet and directly broadcast the latest media fragments updated by the server to rapidly catch up with the media fragment latest issued by the server to ensure the real-time of the live broadcast. A hop occurs during the course of broadcasting the video.

Apparently, the media fragment currently broadcasted by the client and the latest media fragment, updated by server, directly broadcasted by the client are not continuous during the broadcast. The absent media fragment leading to discontinuity is supplemented by the client itself, which is considered in the solution of the present application. After the media fragment currently broadcasted is performed completely, the self-supplemented media fragment is broadcasted, and then the latest media fragment updated by the server is broadcasted. In this way, the complete broadcast in the carousel mode may be ensured.

In step S200, a client sends a request to a server to acquire an index list continuously updated by the server, wherein the index list updated every time is provided with broadcast addresses of multiple latest media fragments to be broadcasted in order and a corresponding unique sequence.

The arrangement sequence between the media fragment and other media fragment is identified through the sequence. Therefore, the sequence itself and the broadcast address of the media fragment have a corresponding relation.

In step S202, the client acquires the updated index list and discards the old index list, records the sequence of a media fragment currently to be downloaded when discarding the old index list, and identifies the sequence of the media fragment ranking in a first broadcast place in the updated index list.

It should be noted that the sequence of the media fragment currently to be downloaded when discarding the old index list is a media fragment that is not downloaded successfully.

In step S204, when comparing and then determining that the two sequences are different and continuous, the client generates a supplemental broadcast address of a corresponding media fragment according to the recorded sequences, sequentially combines the supplemental broadcast address and the broadcast addresses in the updated index list according to the corresponding sequence to obtain a current index list, and downloads the corresponding media fragment from a server for broadcasting according to the broadcast addresses in the current index list in order.

The two sequences are continuous; therefore there is no absent sequence. In this way, the sequence recorded in the step S202 is the media fragment that is not downloaded successfully as long as the broadcast address of the media fragment is acquired. However, the old index list has been discarded, therefore the supplemental broadcast address also needs to be generated.

The corresponding supplemental broadcast address may be generated according to the media fragment with the recorded sequence by means of the corresponding relation between the sequence and the broadcast address of the media fragment. According to the arrangement sequence of sequences, the supplemental broadcast address is arranged between the media fragment currently broadcasted and the latest broadcast address updated by the server.

After broadcasting the current media fragments, the media fragments are firstly downloaded in the supplemental broadcast address for broadcasting, and then the media fragments are downloaded in the latest broadcast address updated by the server for broadcasting. In this way, the broadcast integrity is implemented.

### Third Embodiment

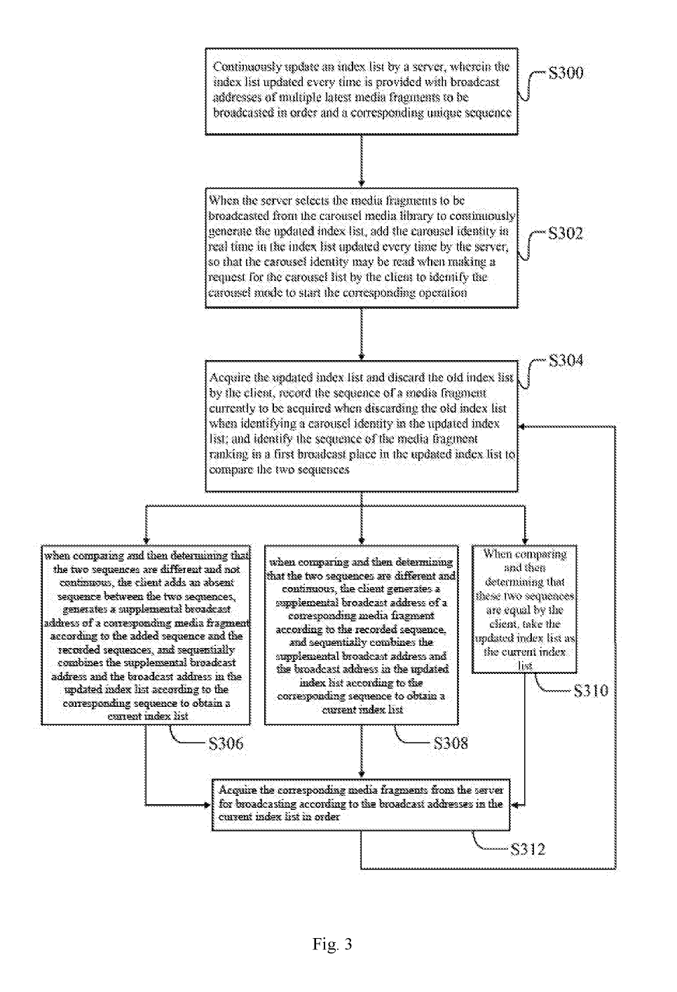

FIG. 3 shows a flowchart of a method according to a third embodiment of the present application. The method includes the following steps.

In step S300, a server updates an index list continuously, wherein the index list updated every time is provided with broadcast addresses of multiple latest media fragments to be broadcasted in order and a corresponding unique sequence.

One sequence will be given to the index list updated every time. The sequence is equal to the unique sequence of the media fragment ranking in the first broadcast place in the index list. The sequence of the media fragment ranking in the second broadcast place after the first broadcast place is added by 1. The sequence of the media fragment ranking in the second broadcast place after the first broadcast place is added by 2. The index list ordinarily has 3 broadcast addresses according to the stipulation of the HLS protocol, and the present application is certainly not limited herein.

The server stores a live media library, an on-demand media library and a carousel media library, wherein each library stores corresponding media fragments to be broadcasted.

For instance, the carousel resource library is stored with carousel media fragments. Multiple media fragments are combined together in order for broadcasting to form a complete video resource. One complete video resource may be a movie or an episode of TV play. The order of combining multiple media fragments together for broadcasting is arranged according to the sequence of each media fragment.

In step S302, when the server selects the media fragments to be broadcasted from the carousel media library to continuously generate the updated index list, the server adds the carousel identity in real time into the index list updated every time, so that the carousel identity may be read when making a request for the carousel list by the client to identify the carousel mode to start the corresponding operation.

In the practical application, the carousel identity is directly added behind each broadcast address in the index list with a symbol.

A request is sent by the client to the server by taking a first time interval as a cycle to acquire an index list updated by the server by taking a second time interval as the cycle, wherein the first time interval is less than the second time interval. Generally speaking, the first time interval is equal to half of the second time interval. The value may make the frequency of sending a request by the client to the server to acquire the updated index list to be greater than the frequency of self-updating the index list by the server, which ensures that the client does not miss the update of the server and that the client does not send the request too frequently so that processing resources are wasted.

In step S304, the client acquires the updated index list and discards the old index list, and records the sequence of a media fragment currently to be downloaded when discarding the old index list after analyzing the carousel identity in the old index list; and it acquires the sequence of the media fragment ranking in the first broadcast place in the updated index list when analyzing the carousel identity in the updated index list to compare the two sequences.

When acquiring the old index list by the client before, the old index list ordinarily has multiple broadcast addresses. There are 3 broadcast addresses stored according to the stipulation of the HLS protocol. The client downloads one media fragment from the server for broadcasting each time according to the broadcast address in the old index list in sequence. If the cache is large enough, one media fragment or even two media fragments may be downloaded when broadcasting the media fragment currently downloaded to deal with the delay of acquiring the data or the updated index list by the server due to the network jittering. When identifying the carousel identity in the old index list, the sequence of the media fragment currently to be downloaded in the old index list is still recorded continuously and the prior record is covered until the sequence of the media fragment currently to be downloaded is finally recorded when discarding the old index list.

The carousel processing is started when identifying the carousel identities in the updated index list. When discarding the old index list by the client, the sequence of the media fragment, which is currently expected to be downloaded but not be downloaded, is identified and recorded. In the meantime, the sequence of the media fragment ranking in the first broadcast place in the updated index list, which is also the sequence of the updated index list, further needs to be identified.

In step S306, when comparing and then determining that the two sequences are different and not continuous, the client adds an absent sequence between the two sequences, generates a supplemental broadcast address of a corresponding media fragment according to the added sequence and the recorded sequences, and sequentially combines the supplemental broadcast address and the broadcast address in the updated index list according to the corresponding sequence to obtain a current index list, and proceeding to step S312.

When comparing and then determining that the two sequences are different and not continuous by the client, it indicates that two sequences are interrupted, for instance, the sequence 4 is absent between the sequence 3 and the sequence 5.

At this point, the media fragment corresponding to the recorded sequence has not been downloaded yet. The media fragment that is not downloaded and the media fragment that has been downloaded before (the media fragment that has been downloaded before may be either being broadcasted or that has not been broadcasted but cached to be broadcasted) are obviously continuous, for instance, the media fragment with the sequence 2 has been downloaded, while the media fragment corresponding to the sequence 3 has not been downloaded yet, and these two media fragments are obviously continuous.

The absent portion between two sequences cannot be obtained. At this point, the absent sequence may be deduced according to the regularity. Both of the media fragments corresponding to the absent sequence and recorded sequence that has not been downloaded need to be downloaded to ensure the continuous broadcast. According to the deduced absent sequence and the recorded sequence, the supplemental broadcast address of the corresponding media fragment is generated in combination with a certain rule (for instance, the broadcast address of the media fragment is also numbered continuously, and the supplemental broadcast address is deduced according to the difference between the sequence to be supplemented and the forward and backward known sequence s as well as the broadcast addresses corresponding to the forward and backward known sequences). For instance, the index list with the sequence 2, the sequence 3 and the sequence 4 has been discarded, the sequences of the updated index list are 5, 6 and 7, while the media fragment with the sequence 2 has been downloaded, and the media fragment corresponding to the sequence 3 has not be downloaded yet, and the sequence 5 is in the first broadcast place of the updated index list and the sequence 4 is absent between the sequence 3 and the sequence 5. Therefore, there is a certain difference between the client and the server. The client generates the supplemental broadcast addresses of the corresponding media fragments according to the sequence 3 and the sequence 4, in combination with the broadcast addresses of the media fragments with the sequence 5, the sequence 6 and the sequence 7 of the updated index list to form the current index list.

In step S308, when comparing and then determining that the two sequences are different and continuous, the client generates a supplemental broadcast address of a corresponding media fragment according to the recorded sequence, and sequentially combines the supplemental broadcast address and the broadcast address in the updated index list according to the corresponding sequence to obtain a current index list, and proceeding to the step S312.

When comparing and then determining that the two sequences are different and continuous by the client, it indicates that two sequences are not interrupted, for instance, the sequence 3 and the sequence 4 are continuous.

The media fragment that is not downloaded and the media fragment that has been downloaded before (the media fragment that has been downloaded before may be either being broadcasted or that has not been broadcasted but cached to be broadcasted) are obviously continuous. The continuous broadcast may be ensured as long as the media fragment corresponding to the recorded sequence that has not been downloaded is downloaded. According to the recorded sequence in combination with a certain rule (for instance, the broadcast address of the media fragment is also numbered continuously, and the supplemental broadcast address is deduced according to the difference between the sequence to be supplemented and the forward and backward known sequences as well as the broadcast addresses corresponding to the forward and backward known sequences), the supplemental broadcast address of the corresponding media fragment is generated. For instance, the index list with the sequence 2, the sequence 3 and the sequence 4 has been discarded, the sequences of the updated index list are 4, 5 and 6, while the media fragment with the sequence 2 has been downloaded, and the media fragment corresponding to the sequence 3 has not be downloaded yet, and the sequence 4 is in the first broadcast place of the updated index list and the sequence 3 and sequence 4 are different and continuous. Therefore, there is a certain difference between the client and the server. The client generates the supplemental broadcast addresses of the corresponding media fragments according to the sequence 3, in combination with the broadcast addresses of the media fragments with the sequence 4, the sequence 5 and the sequence 6 of the updated index list to form a new index list.

In step S310, when comparing and determining that these two sequences are equal by the client, the updated index list is taken as the current index list, and proceeding to step S312.

When comparing and then determining that these two sequences are equal by the client, it indicates that two sequences are not interrupted. For instance, the index list with the sequence 2, the sequence 3 and the sequence 4 has been discarded, the sequences of the updated index list are 3, 4 and 5, while the media fragment of the sequence 2 has been downloaded, the media fragment corresponding to the sequence 3 has not been downloaded, and the sequence 3 is in the first broadcast place of the updated index list, and both the sequence that has not been downloaded and the sequence in the first broadcast place of the updated index list are 3, which indicates that there is no difference between the client and the server at this point. Update is synchronous. The updated index list obtained from the server is the current index list.

In step S312, the corresponding media fragments are downloaded from the server for broadcasting according to the broadcast addresses in the current index list in order.

The client downloads one media fragment from the server for broadcasting each time according to the broadcast addresses in the current index list in sequence. If the cache is large enough, one media fragment or even two media fragments may be downloaded when broadcasting the media fragment currently downloaded to deal with the delay of acquiring the data or the updated index list by the server due to the network jittering. For instance, the current index list includes the media fragments with the sequence 3, the sequence 4, the sequence 5, the sequence 6 and the sequence 7. The client downloads the media fragments according to the broadcast addresses corresponding to these sequences in order until receiving the updated index list by the client, and proceeding to the step S304.

### Fourth Embodiment

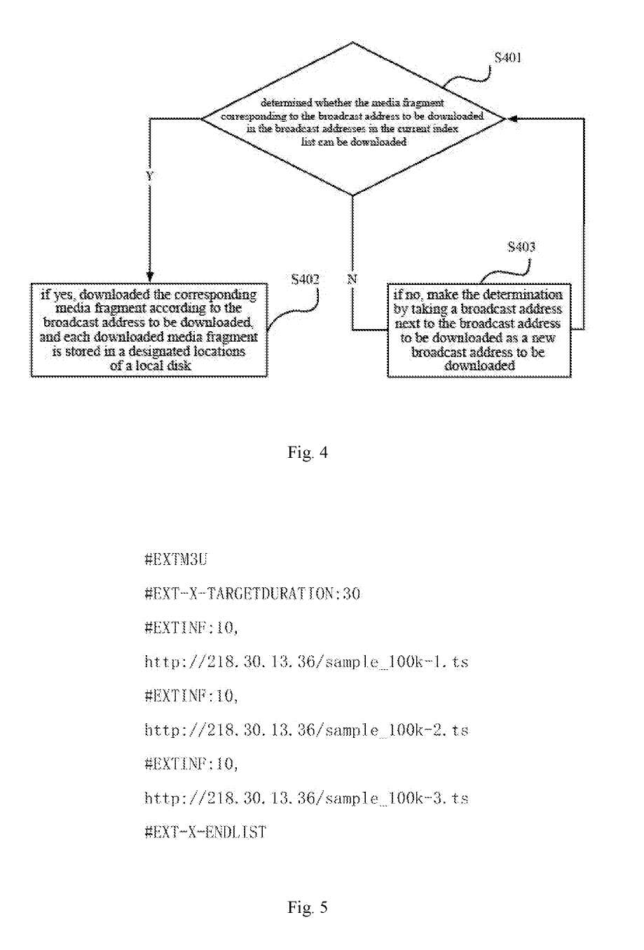

FIG. 4 shows a flowchart of a method according to a fourth embodiment of the present application. Based on the foregoing embodiment, the method for downloading the corresponding media fragment from the server according to the broadcast addresses in the current index list in order includes the following steps.

In step S401, it is determined whether the media fragment corresponding to the broadcast address to be downloaded in the broadcast addresses in the current index list can be downloaded.

In step S402, if yes, the corresponding media fragment is downloaded according to the broadcast address to be downloaded, and each downloaded media fragment is stored in a designated locations of a local disk.

In step S403, if no, the determination is performed by taking a broadcast address next to the broadcast address to be downloaded as a new broadcast address to be downloaded.

The foregoing steps will be described in detail by taking the uniform resource locator (URL) as the broadcast address, the m3u8 file as the index list and the video segment as the media fragment for example hereinafter. However, the present application is not limited to the uniform resource locator (URL) as the broadcast address, the m3u8 file as the index list and the video segment as the media fragment.

According to the HLS protocol, it refers to a schematic diagram of an m3u8 file as shown in FIG. 5.

#EXTM3U represents the m3u file header is placed in the first line.

#EXT-X-TARGETDURATION represents the duration of the largest designated video segment, and the unit is second.

#EXTINF represents the duration of each video segment ts file, which is only effective to the following URL. The duration designated in #EXTINF must be less than or equal to the duration designated in #EXT-X-TARGETDURATION.

http://218.30.13.36/sample_100k-1.ts represents the URL of the media data ts file of the video segment sample_100k-1.

#EXT-X-ENDLIST represents an end of the m3u8 file.

Generally speaking, one complete media corresponds to one m3u8 file, which includes the URL of the multiple video segments of the complete media. According to the present invention, after acquiring the foregoing m3u8 file, the video segments are downloaded from a cloud server in order according to the URL of the video segments in the m3u8 file, and each video segment is stored in the designated location. The designated location is located in the local disk and may be a default location for downloading. For instance, the default location for downloading is C:\Users\Download, or it may be a location self-defined by a user.

The video segments of sample_100k-1.ts, sample_100k-2.ts and sample_100k-3.ts in the foregoing m3u8 file are downloaded in order by still taking the m3u8 file as shown in FIG. 5, for example. During this course, if the video segment corresponding to the certain URL to be downloaded is incapable of being downloaded through the determination, for instance, the video segment sample_100k-2.ts corresponding to the URL:http://218.30.13.36/sample_100k-2.ts to be downloaded is incapable of being downloaded, sample_100k-2.ts is skipped. The URL: http://218.30.13.36/sample_100k-3.ts next to the http://218.30.13.36/sample_100k-2.ts in the foregoing m3u8 file is taken as the URL to be downloaded to make a determination. If the sample_100k-3.ts can be downloaded, the sample_100k-3.ts is continuously downloaded. During the whole course, the sample_100k-3.ts is capable of being downloaded even if the sample_100k-2.ts cannot be downloaded.

According to the above description, it can be seen that during the course of downloading the media fragment, it is determined firstly whether the video segment corresponding to the URL to be downloaded in the m3u8 file can be downloaded. If yes, the corresponding media fragment is downloaded according to the URL; if no, the media fragment is skipped, and the URL next to the URL to be downloaded is taken as a new URL to be downloaded for the determination. Therefore, the media fragment in error may also be skipped to continuously download the next media fragment even if errors occur during the downloading of a certain media fragment; while the faulty problem may be likely to be restored when the media fragments in error are downloaded subsequently. As a result, according to the present invention, the time for waiting for the media fragment in error is reduced during the course of downloading the media and the downloading speed is improved.

The process of further determining whether the media fragment corresponding to the broadcast address to be downloaded in the broadcast addresses in the current index list can be downloaded includes: determining whether the media fragment corresponding to the broadcast address to be downloaded in the broadcast addresses in the current index list is downloaded completely within a predetermined time.

The foregoing steps will be described in detail by taking the uniform resource locator (URL) as the broadcast address, the m3u8 file as the index list and the video segment as the media fragment hereinafter. However, the present application is not limited to the uniform resource locator (URL) as the broadcast address, the m3u8 file as the index list and the video segment as the media fragment.

The further limitation is as follows: the process of determining whether the video segment corresponding to the URL to be downloaded in the foregoing m3u8 file can be downloaded includes: determining whether the video segment corresponding to the URL to be downloaded in the m3u8 file is downloaded completely within a predetermined time.

In the practical application, there are often multiple reasons for being incapable of downloading the video segment, such as, the fault of the cloud server, the network interruption and so on. The video segment corresponding to the URL to be downloaded is incapable of being downloaded completely within a short time regardless of which kind of situations. Therefore, whether the video segment is downloaded with fault is determined by determining whether the video segment is downloaded completely within the predetermined time according to the embodiment. The foregoing predetermined time may be set by an administrator according to the size of the video segment and an average network speed.

Further, the media fragments incapable of being downloaded in the step S403 are downloaded after all media fragments capable of being downloaded have been downloaded completely according to the embodiment. According to the design of the present invention, the video segment with downloading fault is skipped. The video segment without downloading faults is preferably downloaded. The fault video segment skipped before is re-downloaded after all video segments without downloading fault have been downloaded completely. At this point, the faulty problem of the video segment incapable of being downloaded is very likely to be restored, which saves the time of waiting for downloading the fault video segment, thereby improving the downloading speed.

Further limitation is as follows: generating a local index list of the media according to the route of the designated location of the downloaded media fragment.

The foregoing steps will be described in detail by taking the uniform resource locator (URL) as the broadcast address, the m3u8 file as the index list and the video segment as the media fragment hereinafter. However, the present application is not limited to the uniform resource locator (URL) as the broadcast address, the m3u8 file as the index list and the video segment as the media fragment.

Specifically, the local m3u8 file of the target video is generated according to the route of the designated location where the video segment is located.

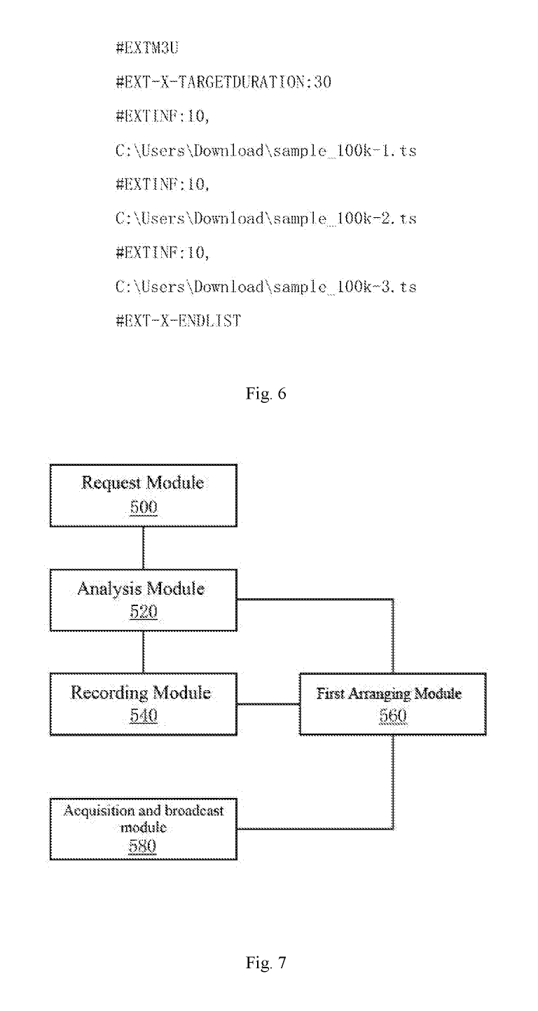

The local m3u8 file is generated while the video segment is downloaded completely according to the embodiment. Preferably, the format of the local m3u8 file is the same as that of the cloud server, but the difference is that the URL in the local m3u8 file is a local address. After the download is completed, the generated local m3u8 file is as shown in FIG. 6 by taking that the video segment in the m3u8 file as shown in FIG. 5 is downloaded to the local disk C:\Users\Download, for example. The foregoing local m3u8 file is generated to achieve the subsequent synthesis and broadcast of the target video.

For the traditional video downloading, one video file is shown for the user after the download is completed, and the user clicks on the video file to achieve the broadcast. After the download is completed, according to the present invention, multiple video segments of the target video are stored. For the user, the broadcast may be achieved by clicking on the local m3u8 file. At present, various players basically support the broadcast of the m3u8 file, for instance, MPlayer, VLC, ffplayer and so on. Thus, it can be seen that it is very convenient to broadcast the video segment by the local m3u8 file, which does not generate an additional operation.

Further, the video segments stored at the designated location may also be combined as the target video according to the foregoing local m3u8 file.

According to the present invention, various video segments of the target video are downloaded and stored respectively, that is to say, the downloaded target video is the assembly of the multiple video segments. There are a great number of files, which is inconvenient for copy. Therefore, the downloaded video segments may be combined as the complete target video according to the foregoing local m3u8 file.

In specific realization of the embodiment, various video segments are combined as a complete target video according to the orders of various video segments in the local m3u8 file. Various video segments may be combined as one video according to a known video combining method. For instance, the video is combined and decoded by a video format coding specification, and then re-combined and coded according to a target format coding specification. By taking the HLS protocol for example, the video segment is the ts format, and a large video file with the ts format may be output after combination. The combination of the video segments may be convenient for the user to copy the target video or to do other operations.

Further limitation is as follows: storing the current index list locally, and marking the broadcast address downloaded completely in the current index list, when restarting the downloading of the media, continuously downloading according to the broadcast address without being marked in the current index list stored locally.

The foregoing steps will be described in detail by taking the uniform resource locator (URL) as the broadcast address, the m3u8 file as the index list and the video segment as the media fragment hereinafter. However, the present application is not limited to the uniform resource locator (URL) as the broadcast address, the m3u8 file as the index list and the video segment as the media fragment.

Specifically, the m3u8 file is stored locally, and the URL that has been downloaded completely is marked in the m3u8. When restarting the downloading of the target video, the URL without being marked in the foregoing m3u8 file stored locally is continuously downloaded.

In other words, a method for continuously downloading the target video is provided in the embodiment. In the practical application, there is a situation that one movie is not downloaded completely, but the user turns off the computer, and the user would like to continue with the download after restarting the computer. Or, the downloading interruption is caused by the network faults, and the downloading needs to be continuously performed when restoring the faults. Which video segments have been downloaded completely and which video segments are not completely need to be known in order to realize the continuous downloading. According to the design of the embodiment, the m3u8 file is stored locally, and the video segment that has been downloaded is marked in the m3u8 file. In this way, when the download is restarted, the video segment that has not been downloaded may be downloaded according to the URL without being marked in the m3u8 file.

Specifically, a predetermined field may be added behind the URL of each video segment of the m3u8 for marking, for instance, the field &downloaded is added for indicating that the video segment has been downloaded completely. In that way, when downloading the target video is restarted, the video segment without being marked with the field &downloaded in the foregoing m3u8 file only needs to be downloaded. Of course, other modes may also be adopted, for instance, a downloading schedule is established locally.

TABLE 1

| URL | Downloading state |
|---|---|
| http://218.30.13.36/sample_100k-1.ts | downloaded |
| http://218.30.13.36/sample_100k-2.ts | downloaded |

By still taking the m3u8 file as shown in FIG. 5 for example, please further refer to Table 1. When the downloading is restarted, the m3u8 file is compared with the foregoing downloading schedule table, and only the absent URL in the downloading schedule table is downloaded, which is http://218.30.13.36/sample 100k-3.ts, to realize the continuous downloading. This is not limited to in the present invention. Those skilled in the art may also adopt other methods to identify the video segments that have been downloaded completely.

### Fifth Embodiment

FIG. 7 shows a structural drawing of a client according to a fifth embodiment of the present application. The client of the carousel media fragment includes a request module 500, an analysis module 520, a recording module 540, a first arranging module 560 and an acquisition and broadcast module 580.

The request module 500 is configured to send a request to a server to acquire an index list continuously updated by the server, wherein the index list updated every time is provided with broadcast addresses of multiple latest media fragments to be broadcasted in order and a corresponding unique sequence.

The analysis module 520 is coupled with the acquisition module 500, and configured to acquire the updated index list and discard the old index list, and notify the recording module 540 when analyzing the carousel identities in the updated index list and the old index list.

The recording module 540 is coupled with the analysis module 520, and configured to record the sequence of a media fragment currently to be downloaded when discarding the old index list after analyzing a carousel identity in the old index list; and acquire the sequence of the media fragment ranking in a first broadcast place in the updated index list when analyzing the carousel identity in the updated index list.

The arranging layout module 560 is coupled respectively with the analysis module 520 and the recording module 540, and it is configured to, when comparing and then determining that the two sequences are different and not continuous, add an absent sequence between the two sequences, generate a supplemental broadcast address of a corresponding media fragment according to the added sequence and the recorded sequences, and sequentially combine the supplemental broadcast address and the broadcast addresses in the updated index list according to the corresponding sequence to obtain a current index list.

The acquisition and broadcast module 580 is coupled with the first arranging module 560 and configured to download the corresponding media fragment from the server for broadcasting according to the broadcast addresses in the current index list in order.

The acquisition module 500 is further configured to send a request to the server by taking a first time interval as a cycle to acquire an index list updated by the server by taking a second time interval as the cycle, wherein the first time interval is less than the second time interval.

According to the analysis module 520, the acquired index list updated every time is provided with a carousel identity added by the server in real time.

The acquisition and broadcast module 580 is further configured to download one media fragment from the server for broadcasting according to the broadcast addresses in the current index list or the old index list in order. If the cache is large enough, one media fragment or even two media fragments may be downloaded when broadcasting the media fragment currently downloaded to deal with the delay of acquiring the data or the updated index list by the server due to the network jittering.

The recording module 540 is further configured to, when identifying the carousel identity in the old index list, the sequence of the media fragment currently to be downloaded in the old index list is recorded continuously and the prior record is covered until the sequence of the media fragment currently to be downloaded is finally recorded when discarding the old index list.

The first arranging module 560 is further configure to, when comparing and then determining that the two sequences are different and continuous, generate a supplement broadcast address of a corresponding media fragment according to the recorded sequence, and sequentially combine the supplemental broadcast address and the broadcast addresses in the updated index list according to the corresponding sequence to obtain a current index list.

The first arranging module 560 is further configured to, when comparing and then determining that these two sequences are equal, take the updated index list as the current index list.

The above shortcomings refer to the first embodiment and the third embodiment.

### Sixth Embodiment

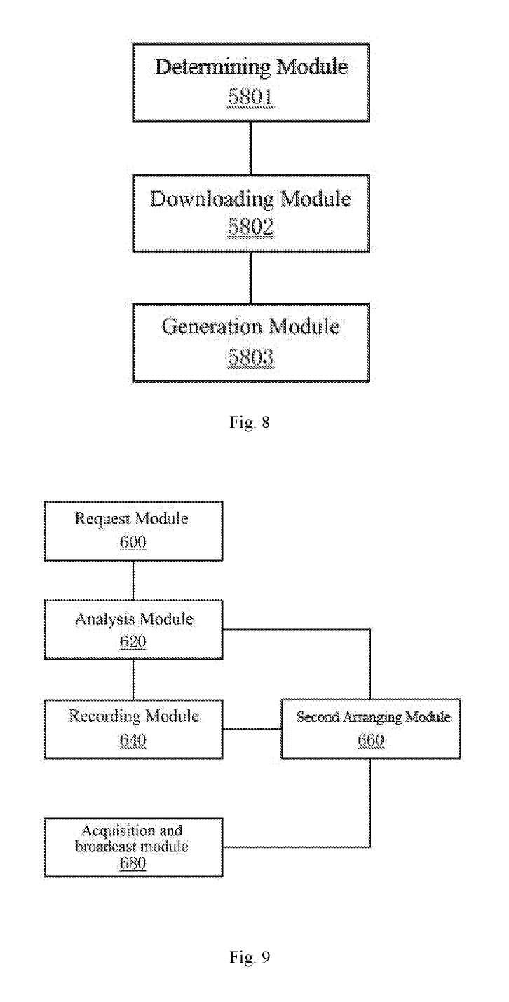

FIG. 8 shows a structural drawing of a client according to a sixth embodiment of the present application. Based on the foregoing embodiment, the acquisition and broadcast module 580 of the embodiment includes a determining module 5801, a downloading module 5802 and a generation module 5803.

The determining module 5801 is configured to determine whether the media fragment corresponding to the broadcast address to be downloaded in the broadcast addresses in the current index list can be downloaded; if yes, send a determination result to the downloading module; if no, make a determination by taking a broadcast address next to the broadcast address to be downloaded as a new broadcast address to be downloaded.

The downloading module 5802 is configure to, when the media fragment corresponding to the broadcast address in the current index list can be downloaded, download the corresponding media fragment according to the broadcast address to be downloaded, and respectively store each downloaded media fragment in a designated location of a local disk.

The generation module 5803 is configured to generate a local index list of the media according to the route of the designated location of the downloaded media fragment.

The foregoing steps will be described in detail by taking the uniform resource locator (URL) as the broadcast address, the m3u8 file as the index list and the video segment as the media fragment hereinafter. However, the present application is not limited to the uniform resource locator (URL) as the broadcast address, the m3u8 file as the index list and the video segment as the media fragment.

The determining module 6801 is configured to determine whether the video segment corresponding to the URL to be downloaded in the foregoing m3u8 file can be downloaded; if yes, send the determination result to the downloading module; if no, make a determination by taking the URL next to the URL to be downloaded as a new URL to be downloaded.

The downloading module 6802 is configured to, when the video segment corresponding to the URL to be downloaded in the foregoing m3u8 file can be downloaded, download the corresponding video segment according to the URL to be downloaded, and respectively store each downloaded video segment in the designated location in the local disk.

The determining module 5801 firstly determines whether the video segment corresponding to the URL to be downloaded in the m3u8 file can be downloaded, and if no, it skips the video segment and make a determination by taking the URL next to the URL to be downloaded as the new URL to be downloaded. If yes, the corresponding video segment is downloaded by the downloading module 5802 according to the URL. Therefore, the video segment in error may also be skipped to continuously download the subsequent video segments when a certain video segment is in errors during download, so that the waiting time is saved and the downloading speed is improved.

Further, after all video segments capable of being downloaded are downloaded completely, the downloading module 5802 downloads the video segment incapable of being downloaded through the determination to achieve the complete downloading of the target video.

The generation module 5803 is configured to generate the local m3u8 file of the target video according to the route of the designated location where the video segment is located, so as to achieve the subsequent combination and broadcast of the target video.

Further, the downloading module 5802 is further configured to store the m3u8 file locally, and the URL that has been downloaded completely is marked in the m3u8 file. When downloading the target video is restarted, the URL without being marked in the m3u8 file stored locally is continuously downloaded. The URL of the video segment without being downloaded in the m3u8 file may be identified by storing the m3u8 file locally and marking the URL that has been downloaded completely, so as to achieve the continuous downloading when the downloading is restarted.

According to the above description, it can be seen that during the course of downloading the media fragment, it is determined firstly whether the video segment corresponding to the URL to be downloaded in the m3u8 file can be downloaded. If yes, the corresponding media fragment is downloaded according to the URL; if no, the media fragment is skipped, and the URL next to the URL to be downloaded is taken as a new URL to be downloaded for determining. Therefore, the media fragment in error may also be skipped to continuously download the next media fragment even if errors occur during the downloading of a certain media fragment; while the faulty problem may be likely to be restored when the media fragments in error are downloaded subsequently. As a result, according to the present invention, the time for waiting for the media fragment in error is reduced during the course of downloading the media and the downloading speed is improved.

### Seventh Embodiment

FIG. 9 shows a structural drawing of a client according to a seventh embodiment of the present application. The client for media fragments carousel includes a request module 600, an analysis module 620, a recording module 640, a second arranging module 660 and an acquisition and broadcast module 680.

The request module 600 is configured to send a request to a server to acquire an index list continuously updated by the server, wherein the index list updated every time is provided with broadcast addresses of multiple latest media fragments to be broadcasted in order and a corresponding unique sequence.

The analysis module 620 is coupled with the acquisition module 600, and configured to acquire the updated index list and discard the old index list, and notify the recording module 640 when analyzing the carousel identities in the updated index list and the old index list.

The recording module 640 is coupled with the analysis module 620, and configured to record the sequence of a media fragment currently to be downloaded when discarding the old index list after analyzing a carousel identity in the old index list; and acquire the sequence of the media fragment ranking in a first broadcast place in the updated index list when analyzing the carousel identity in the updated index list.

The second arranging module 660 is coupled with the analysis module 620 and the recording module 640 respectively and configured to, when comparing and then determining that the two sequences are different and continuous, generate a supplemental broadcast address of a corresponding media fragment according to the recorded sequences, sequentially combine the supplemental broadcast address and the broadcast addresses in the updated index list according to the corresponding sequence to obtain a current index list.

The acquisition and broadcast module 680 is coupled with the second arranging module 660 and configured to download the corresponding media fragment from the server for broadcasting according to the broadcast addresses in the current index list in order.

The request module 600 is further configured to send a request to the server by taking a first time interval as a cycle to acquire an index list updated by the server by taking a second time interval as the cycle, wherein the first time interval is less than the second time interval.

According to the analysis module 620, the acquired index list updated every time is provided with a carousel identity added by the server in real time.

The acquisition and broadcast module 680 is further configured to download one media fragment from the server for broadcasting according to the broadcast addresses in the current index list or the old index list. If the cache is large enough, one media fragment or even two media fragments may be downloaded when broadcasting the media fragment currently downloaded to deal with the delay of acquiring the data or the updated index list by the server due to the network jittering.

The recording module 640 is further configured to, when identifying the carousel identity in the old index list, record continuously the sequence of the media fragment currently to be downloaded in the old index list and cover the prior record until the sequence of the media fragment currently to be downloaded is finally recorded when discarding the old index list.

The first layout module 660 is further configured to, when comparing and then determining that these two sequences are equal, take the updated index list as the current index list.

The above shortcomings refer to the second embodiment and the third embodiment.

### Eighth Embodiment

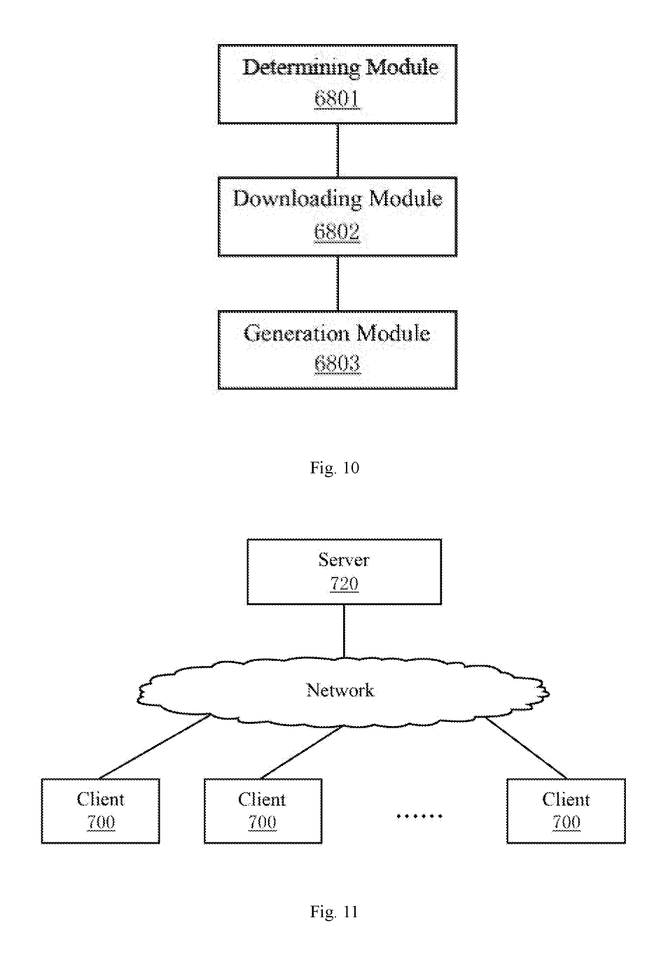

FIG. 10 shows a structural drawing of a client according to an eighth embodiment of the present application. Based on the foregoing embodiment, the acquisition and broadcast module 680 of the embodiment includes a determining module 6801, a downloading module 6802 and a generation module 6803.

The determining module 6801 is configured to determine whether the media fragment corresponding to the broadcast address to be downloaded in the broadcast addresses in the current index list can be downloaded; if yes, send a determination result to the downloading module; if no, make a determination by taking the URL next to the URL to be downloaded as a new URL to be downloaded.

The downloading module 6802 is configured to, when the media fragment corresponding to the broadcast address in the current index list can be downloaded, download the corresponding media fragment according to the broadcast address to be downloaded, and respectively store each downloaded media fragment in designated location of a local disk.

The generation module 6803 is configured to generate a local index list of the media according to the route of the designated location of the downloaded media fragment.

The foregoing steps will be described in detail by taking the uniform resource locator (URL) as the broadcast address, the m3u8 file as the index list and the video segment as the media fragment hereinafter. However, the present application is not limited to the uniform resource locator (URL) as the broadcast address, the m3u8 file as the index list and the video segment as the media fragment.

The determining module 6801 is configured to determining whether the video segment corresponding to the URL to be downloaded in the foregoing m3u8 file can be downloaded; if yes, send the determination result to the downloading module; and if no, make a determination by taking the URL next to the URL to be downloaded as a new URL to be downloaded.

The downloading module 6802 is configured to, when the video segment corresponding to the URL to be downloaded in the foregoing m3u8 file can be downloaded, download the corresponding video segment according to the URL to be downloaded, and respectively store each downloaded video segment in the designated location in the local disk.

The determining module 6801 firstly determines whether the video segment corresponding to the URL to be downloaded in the m3u8 file can be downloaded, and if no, it skips the video segment and make a determination by taking the URL next to the URL to be downloaded as the new URL to be downloaded. If yes, the corresponding video segment is downloaded by the downloading module 6802 according to the URL. Therefore, the video segment in error may also be skipped to continuously download the subsequent video segments when a certain video segment is in errors during download, so that the waiting time is saved and the downloading speed is improved.

Further, after all video segments capable of being downloaded are downloaded completely, the downloading module 6802 downloads the video segment incapable of being downloaded through the determination to achieve the complete downloading of the target video.

The generation module 6803 is configured to generate the local m3u8 file of the target video according to the route of the designated location where the video segment is located, so as to achieve the subsequent combination and broadcast of the target video.

Further, the downloading module 6802 is further configured to store the m3u8 file locally, and mark the URL that has been downloaded completely in the m3u8 file. When downloading the target video is restarted, the URL without being marked in the foregoing m3u8 file stored locally is continuously downloaded. The URL of the video segment without being downloaded in the m3u8 file may be identified by storing the m3u8 file locally and marking the URL that has been downloaded completely, so as to achieve the continuous downloading when the downloading is restarted.

According to the above description, it can be seen that during the course of downloading the media fragment, it is determined firstly whether the video segment corresponding to the URL to be downloaded in the m3u8 file can be downloaded. If yes, the corresponding media fragment is downloaded according to the URL; if no, the media fragment is skipped, and the URL next to the URL to be downloaded is taken as a new URL to be downloaded for determining. Therefore, the media fragment in error may also be skipped to continuously download the next media fragment even if errors occur during the downloading of a certain media fragment; while the faulty problem may be likely to be restored when the media fragments in error are downloaded subsequently. As a result, according to the present invention, the time for waiting for the media fragment in error is reduced during the course of downloading the media and the downloading speed is improved.

### Ninth Embodiment

FIG. 11 shows a frame chart of a system according to a ninth embodiment of the present application. The system includes one or more clients 700 and a server 720.

The client 700 includes the client of the carousel media fragments as shown in FIG. 7 or FIG. 9, with reference to the fourth embodiment and the fifth embodiment, which is not elaborated any more herein. The client may be a network TV, a tablet computer, a personal computer, a network video player (network set-top box), a mobile phone and so on, which is not limited in the present application.

The server 720 is configured to update an index list continuously, wherein the index list updated every time is provided with broadcast addresses of multiple latest media fragments to be broadcasted in order and a corresponding unique sequence.

One sequence will be given to the index list updated every time. The sequence is equal to the unique sequence of the media fragment ranking in the first broadcast place in the index list. The sequence of the media fragment ranking in the second broadcast place after the first broadcast place is added by 1. The sequence of the media fragment ranking in the second broadcast place after the first broadcast place is added by 2. The index list ordinarily has 3 broadcast addresses according to the stipulation of the HLS protocol, and the present application is certainly not limited herein.

The server 720 stores a live broadcast media library, an on-demand media library and a carousel media library, wherein each library is stored with corresponding media fragments to be broadcasted. For instance, the carousel resource library is stored with carousel media fragments. Multiple media fragments are combined together in sequence for broadcasting to form a complete video resource. One complete video resource may be a movie or an episode of TV play. The order of combining multiple media fragments together for broadcasting is arranged according to the sequence of each media fragment.

When the server 720 selects the media fragments to be broadcasted from the carousel media library to continuously generate the updated index list, the server adds the carousel identity in real time in the index list updated every time, so that the carousel identity may be read when making a request for the carousel list by the client to identify the carousel mode to start the corresponding operation. In the practical application, the carousel identity is directly added behind each broadcast address in the index list with a symbol.

The above shortcomings refer to the foregoing method embodiment and device embodiment.

### Application Example

The server is a broadcasting control server of video resources established by some network video service provider. The broadcasting control server supports the HLS protocol, and supports the carousel mode configuration performed in the above embodiments on the basis of the HLS protocol. The client is a certain brand of network TV launched by the network video service provider, which is installed with various modules described in the above embodiments.

The server stores a live broadcast library, an on-demand media library and a carousel media library. The server is in a live broadcast of a football match at present. The live broadcast library is stored with the media fragments manufactured in real time according to the live broadcast match and is provided with an index list by the HLS live broadcast mode. The network TV is watching the football match by updating the index list. However, the network TV fails to maintain the synchronization with the server due to the effect of poor network condition, and continuously discards the media fragments to rapidly catch up with the live broadcast of the server. The hopped picture makes the user feel uncomfortable.

The user operates the network TV to switch the channel to start watching some carousel TV series ABC. Without depending on the solution of the present application, the hopped broadcast picture with discarding frames is the same as the live broadcast of the football match during the carousel of the TV series ABC. However, after adopting use of the solution of the present application, firstly, the server takes 20-second as a cycle and updates the index list continuously according to the media fragments of the TV series ABC. According to the HLS protocol, the currently updated index list 1 is provided with a broadcast address URL2, a broadcast address URL3 and a broadcast address URL4 of three latest media fragments of the TV series ABC to be broadcasted in order as well as a corresponding sequence 2, the corresponding sequence 3 and a corresponding sequence 4. The server adds a carousel identity t behind the broadcast address URL in the index list 1 in real time. The sequence of the index list 1 is equal to the sequence of the URL2 ranking in the first broadcast place in the index list 1. The subsequent URL3 and URL4 are added with 1, which may deduce the sequence s are 3 and 4.

Sequence 2
URL2-t
URL3-t
URL4-t
Index list 1

The client acquires the foregoing index list 1, firstly broadcasts the media fragment of the URL2-t downloaded from the server according to the broadcast address in the index list 1 in sequence, and then simultaneously downloads the media fragment of the URL3-t from the server when broadcasting the media fragment of the URL2-t. In addition, when the client reads the broadcast address in the index list 1, the carousel identity t is identified and the current index list is known in the carousel mode. At this point, the sequence of the media fragment currently to be downloaded in the old index list needs to be continuously recorded and the prior record is covered. When performing the above operation according to the index list 1, the client makes a request for the updated index list to the server by taking 10-second as the cycle.

The server generates the updated index list 2, the updated index list 3 and the updated index list 4 according to the media fragment of the TV series ABC in order. According to the HLS protocol, the index list 2 is provided with a broadcast address URL3, a broadcast address URL4 and a broadcast address URL5 of three latest media fragments of the TV series ABC to be broadcasted in order as well as a corresponding sequence 3, the corresponding sequence 4 and a corresponding sequence 5; the index list 3 is provided with a broadcast address URL4, a broadcast address URL5 and a broadcast address URL6 of three latest media fragments of the TV series ABC to be broadcasted in order as well as the corresponding sequence 4, the corresponding sequence 5 and a corresponding sequence 6; and the index list 4 is provided with a broadcast address URL5, a broadcast address URL6 and a broadcast address URL7 of three latest media fragments of the TV series ABC to be broadcasted in order as well as the corresponding sequence 5, the corresponding sequence 6 and a corresponding sequence 7. The server adds the carousel identity t behind the broadcast address URL in the index list 2, the index list 3 and the index list 4 in real time. The sequence of the index list 2 is equal to the sequence of the URL3 ranking in the first broadcast place in the index list 2. The sequence of the index list 3 is equal to the sequence of the URL4 ranking in the first broadcast place in the index list 3. The sequence of the index list 4 is equal to the sequence of the URL5 ranking in the first broadcast place in the index list 4.

| Sequence 3 | Sequence 4 | Sequence 5 |
|---|---|---|
| URL3-t | URL4-t | URL5-t |
| URL4-t | URL5-t | URL6-t |
| URL5-t | URL6-t | URL7-t |
| Index list 2 | Index list 3 | Index list 4 |

The client does not acquire the index list 2 and the index list 3 by this time due to the effect of the network jittering, but only acquires the latest index list 4 later. At this point, the old index list 1 needs to be discarded according to the HLS protocol. The sequence of the finally recorded media fragment URL3 currently to be downloaded is 3 when discarding the index list 1.

When the client reads the broadcast address in the latest index list 4, the carousel identity t is identified, then the sequence 5 of the media fragment URL5 ranking in the first broadcast place in the latest index list 4 is automatically acquired. The finally recoded sequence 3 when discarding the index list 1 and the sequence 5 ranking in the first broadcast place in the index list 4 are compared.

Obviously, the sequence 3 and the sequence 5 are different and not continuous. The supplemental broadcast address of the corresponding media fragment is generated according to the absent sequence 4 between these two sequences and the recorded sequence 3. As the sequence of the URL5 is 5, but the sequence of the URL is 2, it may be deduced according to such rule that the broadcast address of the sequence 3 is URL3, the broadcast address of the sequence 4 is URL4, and both the URL3 and the URL 4 are the supplemental broadcast addresses.

The supplemental broadcast address URL3 and the supplemental broadcast address URL4, as well as the broadcast address URL5, the broadcast address URL6 and the broadcast address URL7 in the latest index list 4 are combined in order according to the corresponding sequence to obtain the current index list. At this point, the current index list is not only provided with the broadcast addresses of three latest media fragments without following the HLS protocol, and it is stored with the broadcast addresses of the corresponding number of latest media fragments according to the practical situation.

Sequence 5
URL3-t
URL4-t
URL5-t
URL6-t
URL7-t
Current index list

The client downloads one media fragment from the server every time for broadcasting according to the broadcast address in the current index list in order until receiving the updated index list by the client again.

It should be finally noted that in the text, the relation terms such as the first and the second are only used for distinguishing an entity or operation from another entity or operation, which do not always request or mean that these entities or operations have any such practical relation or order. Moreover, the terms “include”, “comprise” or any variation thereof herein refer to “including but not limited to”. Therefore, regarding a process, method, article or device that includes a series of elements, the process, method, article or device not only includes such elements, but also includes other elements not specified expressly, or may include inherent elements of the process, method, article or device. Without more limitations, in the context of “include a . . . ”, the process, method, article or device that includes or comprises the elements may also include other identical elements.

A method, client and system for media fragments carousel provided in the present invention are introduced in details above. The principle and the embodiment of the present invention are illustrated by applying a specific example in the context. The description of the embodiment above is merely configured for helping understand the method and the core thought thereof of the present application. At the same time, those ordinary skilled in the part may change the detailed description and the application scope according to the thought of the present invention. In conclusion, the content of the description shall not be understood as the limit to the present invention.

### INDUSTRIAL APPLICABILITY

By applying the technical solution above, the method, the client and the system for carousel the media fragments provided by the present application may ensure the integrity of the user broadcasting media; it may ensure that the client does not miss the updating of the server and does not make requests too frequently so that processing resources are wasted; and in addition, it may deal with the delay of acquiring the data or updating the index list by the server due to network jittering.

1. A method of a carousel media fragment, wherein comprising:
acquiring an index list continuously updated by a server, wherein the index list updated every time is provided with broadcast addresses of multiple latest media fragments to be broadcasted in order and a corresponding unique sequence;
acquiring the updated index list and discarding an old index list, recording a sequence of a media fragment currently to be downloaded when discarding the old index list, and identifying a sequence of a media fragment ranking in a first broadcast place in the updated index list; and
when determining that the two sequences are different and not continuous, adding an absent sequence between the two sequences, generating a supplemental broadcast address of a corresponding media fragment according to the added sequence and the recorded sequence, sequentially combining the supplemental broadcast address and the broadcast addresses in the updated index list according to a corresponding sequence to obtain a current index list, and downloading a corresponding media fragment from a server for broadcasting according to the broadcast addresses in the current index list in order.

2. The method according to claim 1, wherein the operation of acquiring the index list continuously updated by the server further comprises:
sending a request to the server by taking a first time interval as a cycle to acquire an index list updated by the server by taking a second time interval as the cycle, wherein the first time interval is less than the second time interval.

3. The method according to claim 1, wherein,
the index list updated every time is further provided with a carousel identity added by the server in real time;
when a client identifies the carousel identity in the updated index list, recording the sequence of the media fragment currently to be downloaded when discarding the old index list, and identifying the sequence of the media fragment ranking in the first broadcast place in the updated index list.

4. The method according to claim 1, wherein,
when determining that the two sequences are different and continuous, generating the supplemental broadcast address of the corresponding media fragment according to the recorded sequences, sequentially combining the supplemental broadcast address and the broadcast addresses in the updated index list according to the corresponding sequence to obtain the current index list, and downloading the corresponding media fragment from the server for broadcasting according to the broadcast addresses in the current index list in order.

5. The method according to claim 1, wherein, the method for downloading the corresponding media fragment from the server according to the broadcast addresses in the current index list in order comprises:
determining whether a media fragment corresponding to a broadcast address to be downloaded in the broadcast addresses of the current index list is downloaded;
if yes, downloading the corresponding media fragment according to the broadcast address to be broadcasted, and respectively storing each downloaded media fragment in a designated location of a local disk; and
if no, taking a broadcast address next to the broadcast address to be downloaded as a new broadcast address to be downloaded, and making a determination.

6. The method according to claim 5, wherein, the process of determining whether the media fragment corresponding to the broadcast address to be downloaded in the broadcast addresses in the current index list is downloaded comprises: determining whether the media fragment corresponding to the broadcast address to be downloaded in the broadcast addresses in the current index list is downloaded completely within a predetermined time.

7. The method according to claim 5, wherein the method further comprises: after all media fragments which can be downloaded have been downloaded, downloading media fragments which cannot be downloaded.

8. The method according to claim 5, wherein the method further comprises: generating a local index list of the media according to a route of the designated location of the downloaded media fragment.

9. The method according to claim 5, wherein the method further comprises: storing the current index list locally, and marking the broadcast addresses which has been downloaded completely in the current index list, when restarting the downloading of the media, continuously downloading according to broadcast addresses without being marked in the current index list stored locally.

10. A computer-readable storage medium recording a program configured to execute the method according to claim 1.

11. A client of a carousel media fragment, wherein comprising: a request module, an analysis module, a recording module, a arranging module and an acquisition and broadcast module; wherein
the request module is configured to send a request to a server to acquire an index list continuously updated by the server, wherein the index list updated every time is provided with broadcast addresses of multiple latest media fragments to be broadcasted in order and a corresponding unique sequence;
the analysis module is configured to acquire the updated index list and discard an old index list, and identity a sequence of a media fragment ranking in a first broadcast place in the updated index list;
the recording module is configured to record a sequence of a media fragment currently to be downloaded when discarding the old index list, and identifying the sequence of the media fragment ranking in a first broadcast place in the updated index list;
the arranging module is configured to, when comparing and then determining that the two sequences are different and not continuous, add an absent sequence between the two sequences, generate a supplemental broadcast address of a corresponding media fragment according to the added sequence and the recorded sequences, and sequentially combine the supplemental broadcast address and the broadcast addresses in the updated index list according to a corresponding sequence to obtain a current index list; and
the acquisition and broadcast module is configured to download the corresponding media fragment from a server for broadcast according to broadcast addresses in the current index list in order.

12. The client according to claim 11, wherein the analysis module is configured to send a request to the server by taking a first time interval as a cycle to acquire an index list updated by the server by taking a second time interval as a cycle, wherein the first time interval is less than the second time interval.

13. The client according to claim 11, wherein the request module is configured to send a request to a server to acquire an index list continuously updated by the server, wherein the index list updated every time is further provided with a carousel identity added by the server in real time; when the client identifies the carousel identity in the updated index list, record the sequence of a media fragment currently to be downloaded when discarding the old index list, and identify the sequence of the media fragment ranking in a first broadcast place on the updated index list.

14. The client according to claim 11, wherein the arranging module is further configured to, when comparing and then determining that the two sequences are different and continuous, generate a supplemental broadcast address of a corresponding media fragment according to the recorded sequences, sequentially combine the supplemental broadcast address and the broadcast addresses in the updated index list according to the corresponding sequence to obtain the current index list, and download the corresponding media fragment from the server for broadcasting according to the broadcast addresses in the current index list in order.

15. The client according to claim 11, wherein the acquisition and broadcast module comprises a determining module and a downloading module, wherein
the determining module is configured to determine whether a media fragment corresponding to a broadcast address to be downloaded in the broadcast addresses in the current index list is downloaded; if yes, send a determining result to the downloading module; if no, take a broadcast address next to the broadcast address to be downloaded as a new broadcast address to be downloaded and make a determination;
the downloading module is configured to, when the media fragment corresponding to the broadcast address in the current index list is downloaded, download the corresponding media fragment according to the broadcast address to be downloaded, and respectively store each downloaded media fragment in a designated location of a local disk.

16. The client according to claim 15, wherein the process of determining by the determining module whether the media fragment corresponding to the broadcast address to be downloaded in the broadcast addresses in the current index list is downloaded comprises: determining whether the media fragment corresponding to the broadcast address to be downloaded in the current index list is downloaded completely within a predetermined time.

17. The client according to claim 15, wherein the downloading module is further configured to, after all media fragments which can be downloaded have been downloaded, download media fragments which cannot be downloaded through the determination.

18. The client according to claim 15, wherein the acquisition and broadcast module further comprises: a generation module, configured to generate a local index list of the media according to a route of the designated location of the downloaded media fragment.

19. The client according to claim 15, wherein the downloading module is further configured to store the current index list locally, and mark the broadcast addresses which has been downloaded completely in the current index list, when the downloading of the media is restarted, continuously perform downloading according to broadcast addresses without being marked in the current index list stored locally.

20. A system of a carousel media fragment, wherein comprising one or more clients and servers, wherein
the client, comprising the client of the carousel media fragments according to clam 11; and
the server, configured to continuously update an index list, wherein an index list updated every time is provided with broadcast addresses of multiple latest media fragments to be broadcasted in order and a corresponding unique sequence.
